(19) United States
(12) Patent Application Publication
(10) Pub. No.: US 2019/0269950 A1
(43) Pub. Date: Sep. 5, 2019

(54) AIR BLAST VALVE

(71) Applicant: IDG Finance S.á .r.l., Luxembourg (LU)

(72) Inventor: Timo Karkkulainen, Vantaa (FI)

(21) Appl. No.: 16/418,088

(22) Filed: May 21, 2019

Related U.S. Application Data
(63) Continuation of application No. PCT/FI2017/050799, filed on Nov. 21, 2017.

(30) Foreign Application Priority Data
Nov. 21, 2016 (FI) 20165872

(51) Int. Cl. A62C 2/14; F24F 11/89; F24F 13/15

(52) U.S. Cl. CPC A62C 2/14; F24F 13/15; F24F 11/89

(57) ABSTRACT

Described is a blast valve comprising a frame (1) having a first elongated side member (2), a second elongated side member (3), an elongated bottom member (4), and an elongated top member (5). A plurality of parallel rows of closure devices (7) arranged in the frame (1). The first elongated side member (2) being attached to the elongated bottom member (4) and to the elongated top member (5) by external fastening means (8), and the second elongated side member (3) being attached to the elongated bottom member (4) and to the elongated top member (5) by external fastening means (8).

### FIELD OF THE INVENTION

The invention relates to a blast valve as defined in the preamble of independent claim 1.

The invention relates especially to blast valves designed for industrial use to protect personnel and critical equipment against blast wave created by an explosion in an industrial facility such as in an oil and/or gas platform or in an oil refinery.

Publication FI 124126 presents a blast valve.

One problem with the blast valve presented in publication FI 124126 is that if the size of the blast valve is large such as if the blast valve comprises over six parallel rows of closure devices each row comprising over ten closure devices, transportation of the blast valve to the mounting site is a problem.

### OBJECTIVE OF THE INVENTION

The object of the invention is to solve the above identified problem.

### Short Description of the Invention

The blast valve of the invention is characterized by the definitions of independent claim 1. Preferred embodiments of the blast valve are defined in the dependent claims.

### LIST OF FIGURES

In the following the invention will described in more detail by referring to the figures, of which

FIG. 1 shows an embodiment of the blast valve,

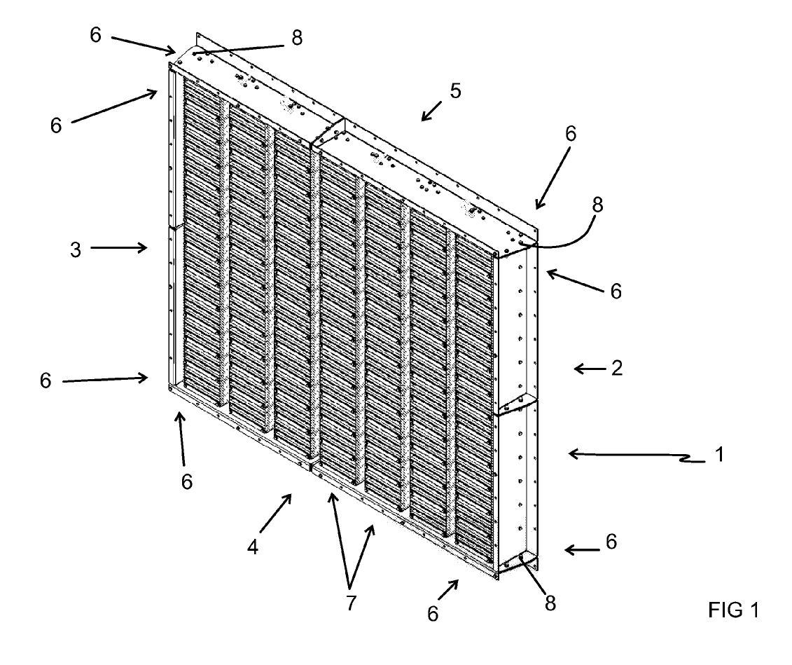

FIG. 2 shows the frame of the blast valve shown in FIG. 1,

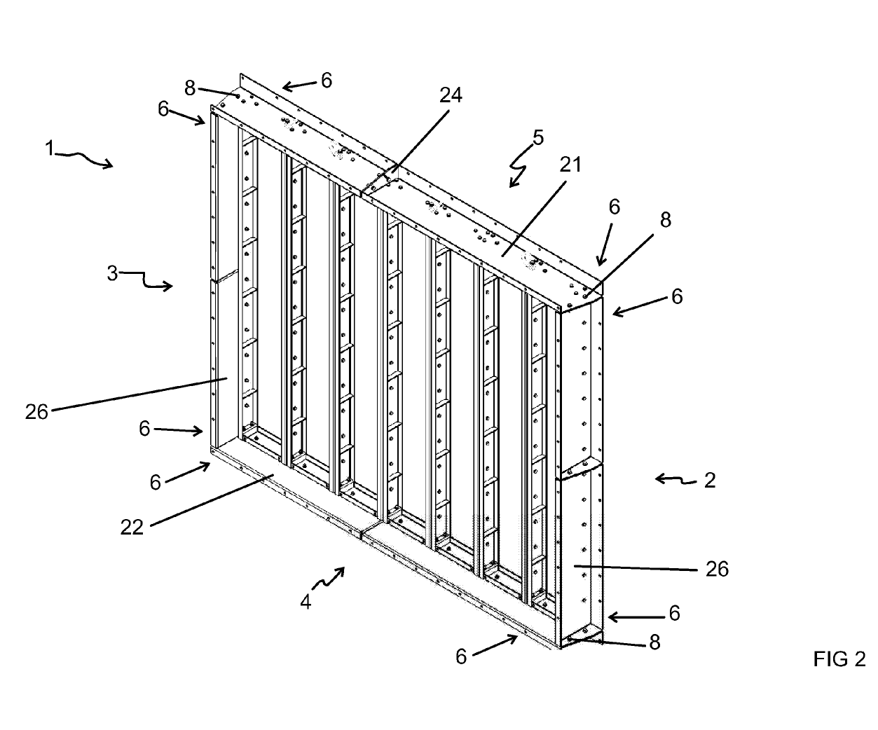

FIG. 3 is an explosion view of the frame shown in FIG. 2 showing the outer frame and the inner frame separated from each other,

FIG. 4 shows the inner frame of the frame shown in FIG. 2,

FIG. 5 shows a frame section of the inner frame shown in FIG. 4,

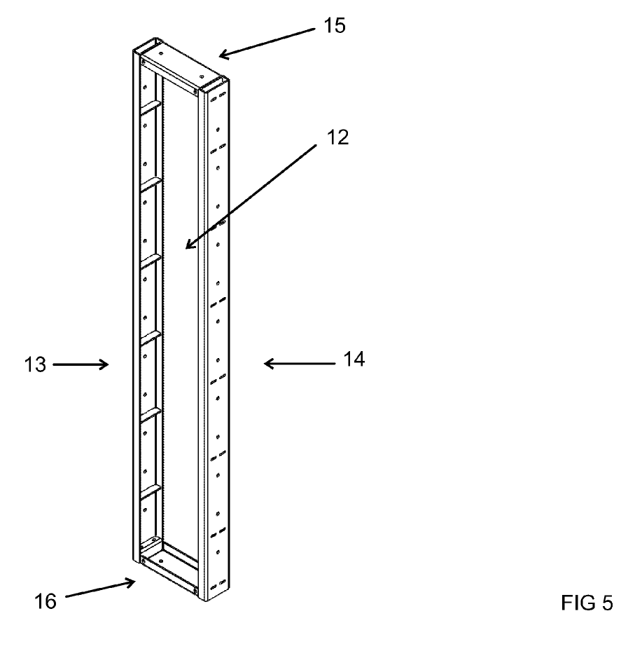

FIG. 6 shows the frame section shown in FIG. 5 in a state, where a row of closure devices is arranged in the frame section,

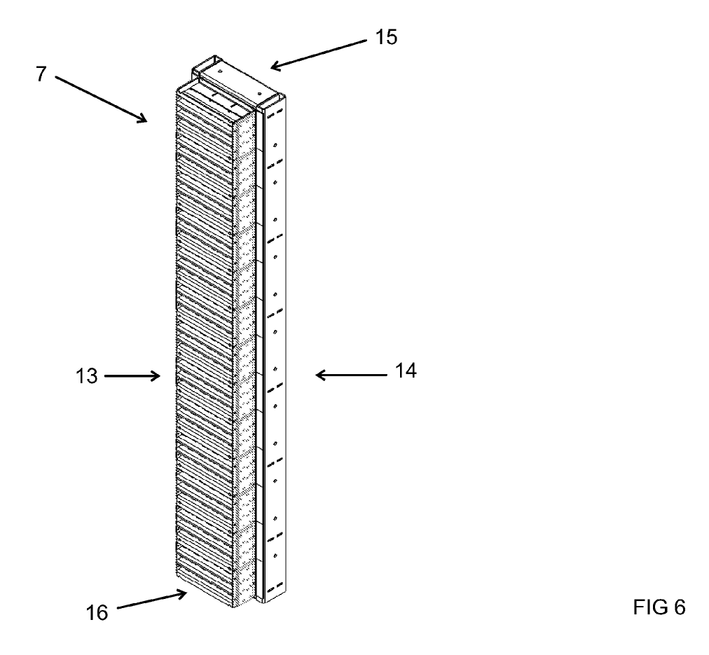

FIG. 7 shows one of a first vertical beam and second vertical beam of the frame section shown in FIG. 5,

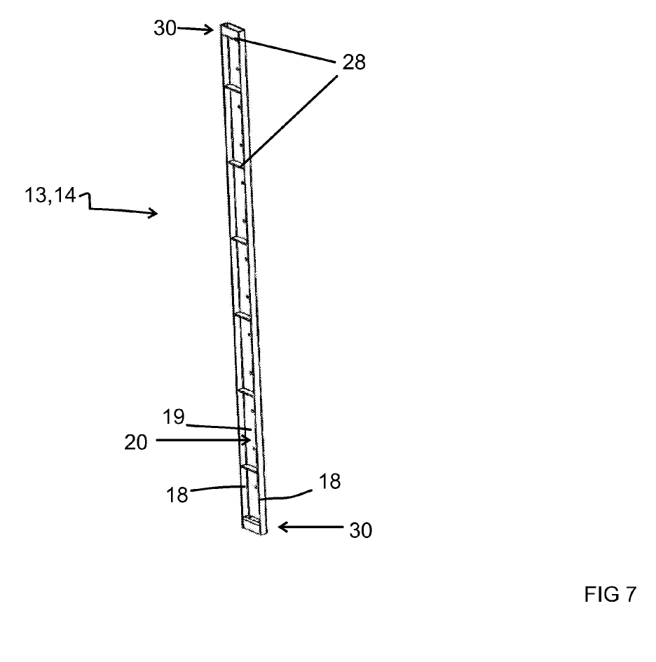

FIG. 8 shows one of an upper horizontal beam and a lower horizontal beam of the frame section shown in FIG. 5,

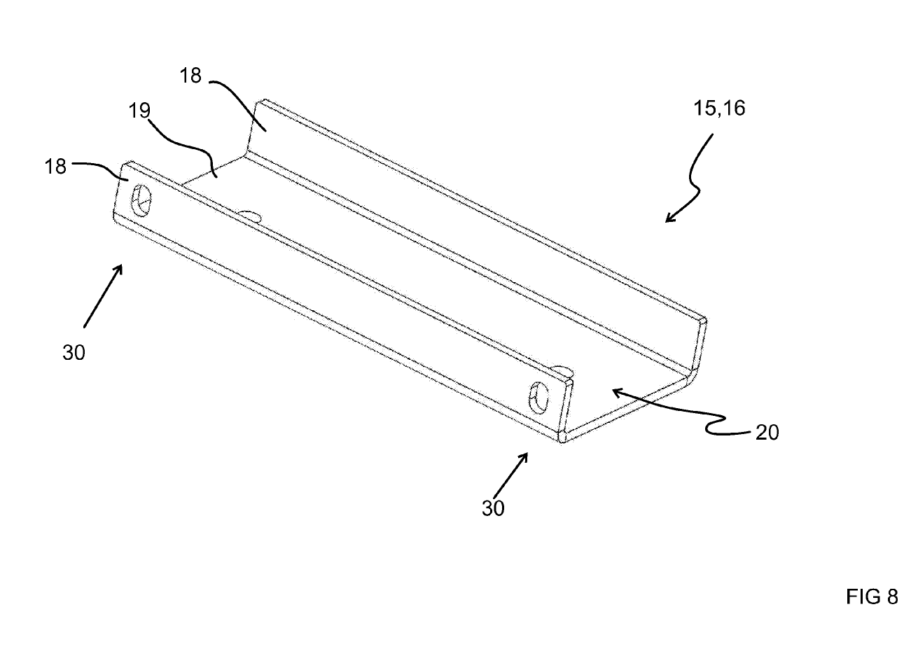

FIG. 9 shows the outer frame of the frame shown in FIG. 2,

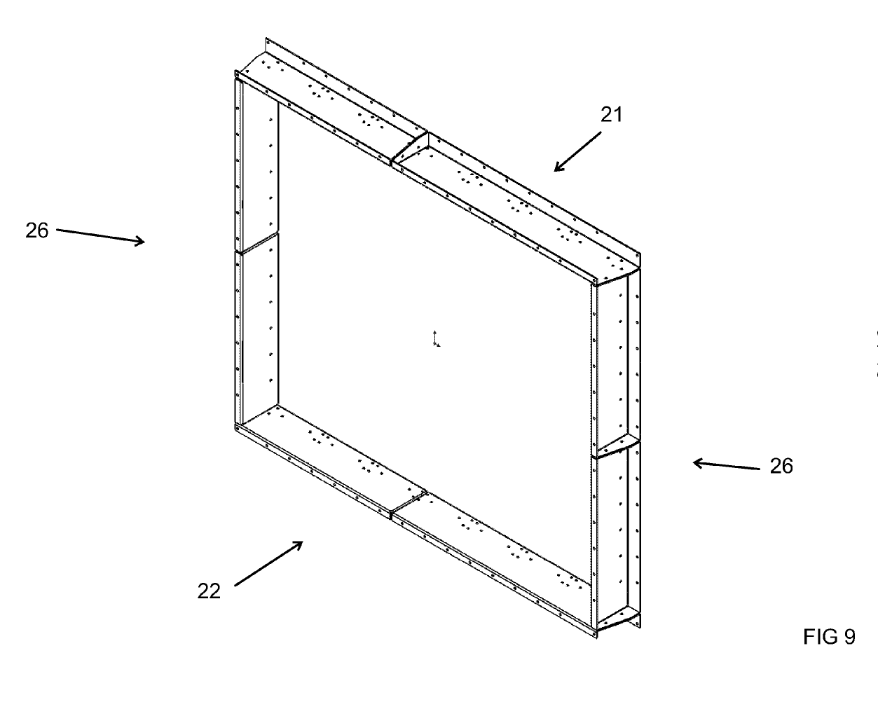

FIG. 10 shows two outer vertical beams connected together of the outer frame shown in FIG. 9,

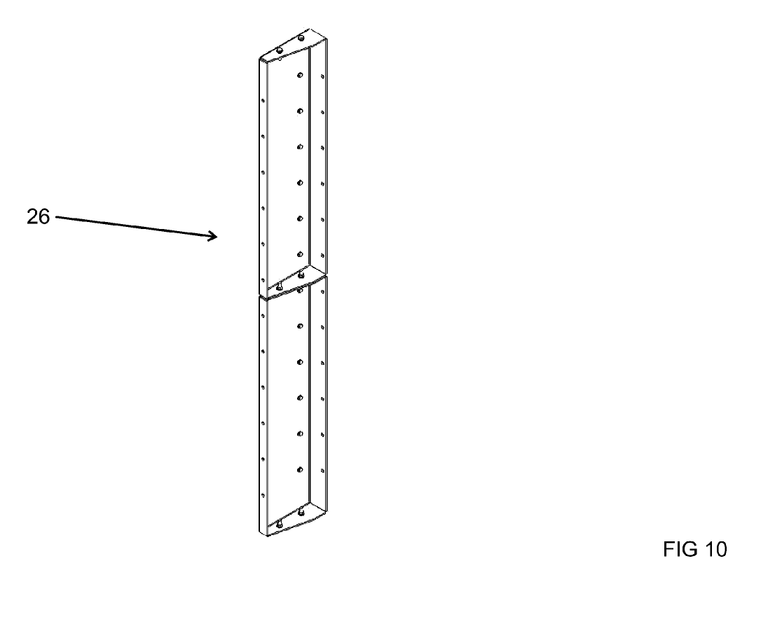

FIG. 11 shows one of two outer upper horizontal beams connected together and two outer lower horizontal beams connected together of the outer frame shown in FIG. 9,

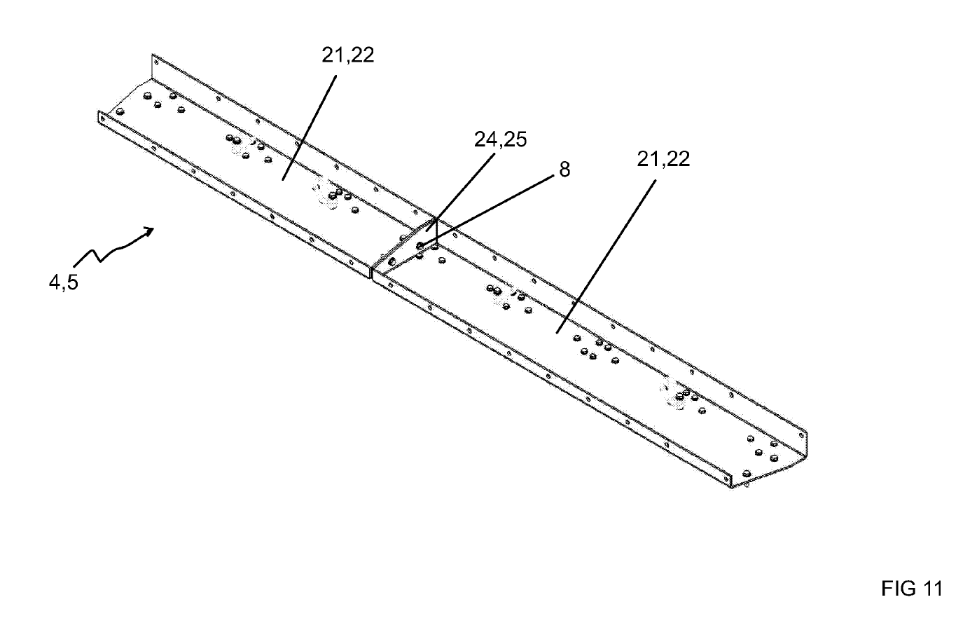

FIG. 12 shows one of a

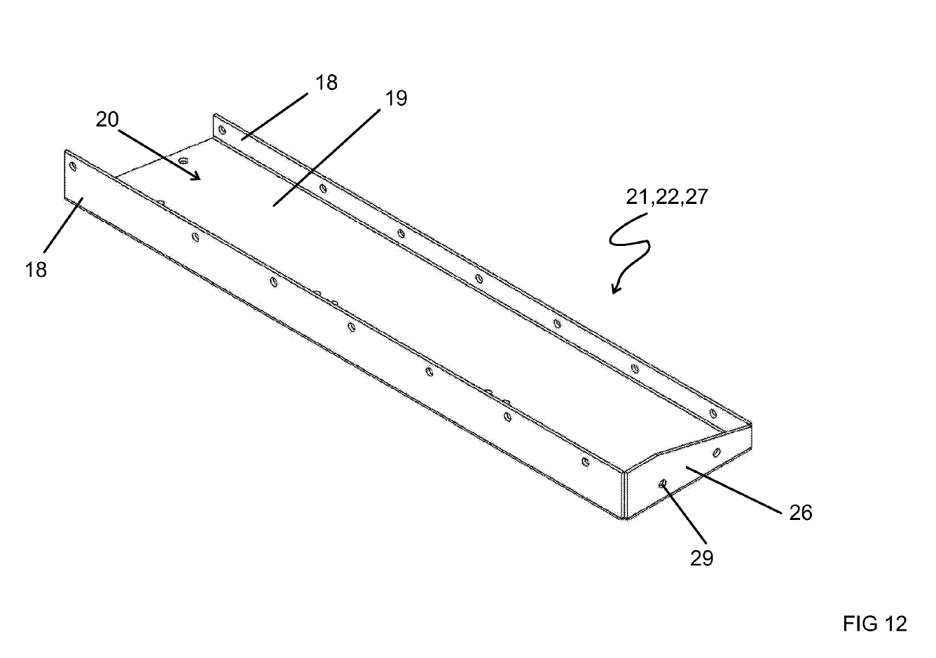

FIG. 13 shows a row of closure devices of the blast valve shown in FIG. 1,

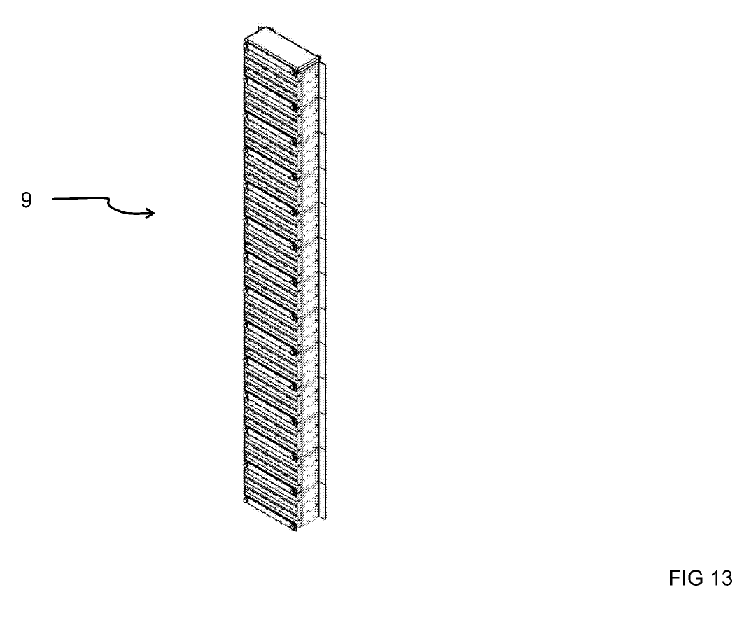

FIG. 14 the blast valve illustrated in FIG. 1, which blast valve comprises and can be divided into two frame sections

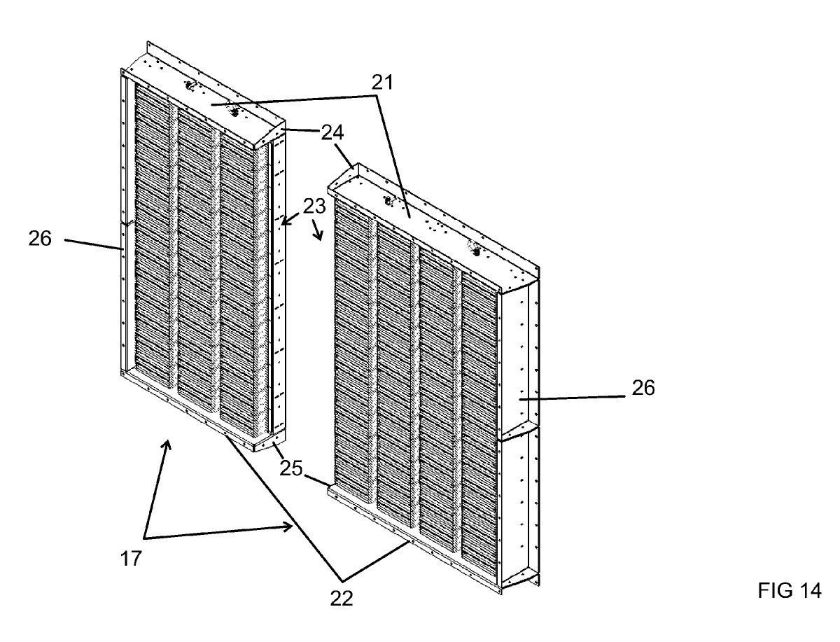

FIG. 15 shows a blast valve section,

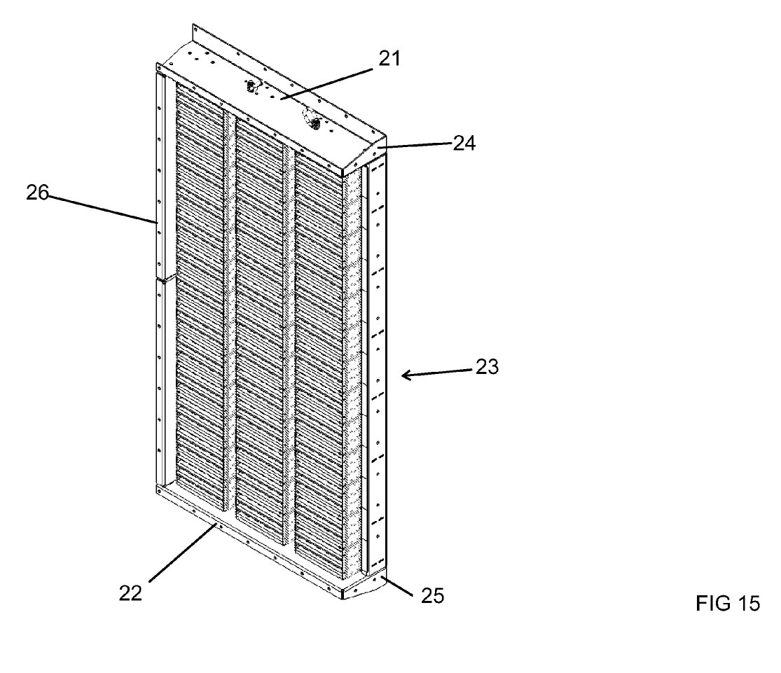

FIG. 16 shows a blast valve section.

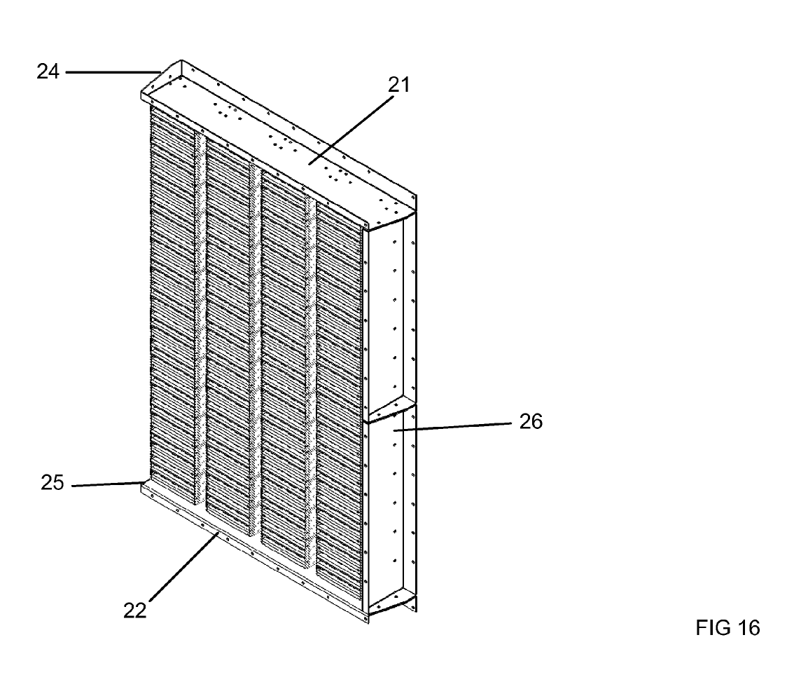

FIG. 17 shows the frame of the blast valve illustrated in FIG. 1, which frame comprises and can be divided into two frame sections, and

FIG. 18 shows the outer frame of the blast valve illustrated in FIG. 1, which outer frame comprises and can be divided into two outer frame sections.

### DETAILED DESCRIPTION OF THE INVENTION

The figures show an embodiment of the blast valve.

The blast valve comprises a frame 1 having a first elongated side member 2, a second elongated side member 3, an elongated bottom member 4, and an elongated top member 5.

The first elongated side member 2 and the second elongated side member 3 are parallel and the elongated bottom member 4 and the elongated top member 5 are parallel.

Each of the first elongated side member 2, the second elongated side member 3, the elongated bottom member 4 and the elongated top member 5 have two opposite first ends 6.

One of the opposite first ends 6 of the first elongated side member 2 is attached to one of the opposite first ends 6 of the elongated bottom member 4 and the other of the opposite first ends 6 of the first elongated side member 2 is attached to one of the opposite first ends 6 of the elongated bottom member 4.

One of opposite first ends 6 of the second elongated side member 3 is attached to one of the opposite first ends 6 of the elongated bottom member 4 and the other of the opposite first ends 6 of the second elongated side member 3 is attached to one of the opposite first ends 6 of the elongated bottom member 4.

A plurality of parallel rows of closure devices 7 arranged in the frame 1.

The number of closure devices in each parallel row of closure devices can for example be between 2 and 20. The number of parallel rows of closure devices can for example be between 2 and 20.

The closure devices 7 are preferably, but not necessarily, closure devices 7 of the type as presented in publication WO 2016/0135380 or in publication U.S. Pat. No. 4,733,606.

The closure devices 7 are preferably, but not necessarily, attached to the frame 1 by means of external fastening means 8.

The first elongated side member 2 is attached to the elongated bottom member 4 and to the elongated top member 5 by external fastening means 8, and the second elongated side member 3 is attached to the elongated bottom member 4 and to the elongated top member 5 by external fastening means 8. This makes is possible to transport the frame 1 of the blast valve in pieces to the site where the blast valve is mounted, which reduces the transportation costs and makes the transportation easier.

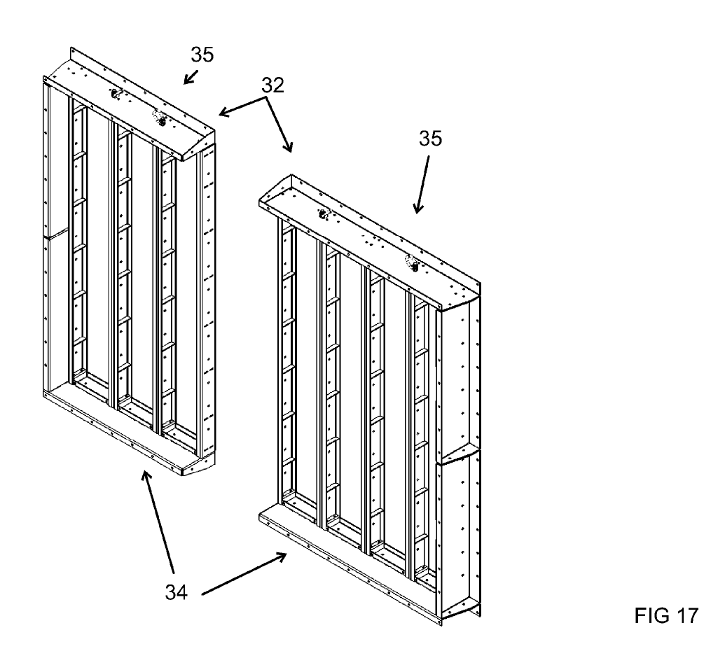

The frame 1 of the blast valve comprises preferably, but not necessarily, as shown in FIG. 17, at least two frame sections 32 joined together by external fastening means 8 to form the frame 1, so that each frame section 32 comprising an elongated bottom member section 34 that forms a part of the elongated bottom member 4 and an elongated top member section 35 that forms a part of the elongated top member 5. In such case, one frame section 32 may comprise the first elongated side member 2, and another frame section 32 may comprise the second elongated side member 3. Dividing the frame 1 into such frame sections 32, facilitates manufacturing and transportation of the blast valve to the site where the blast valve is to be mounted.

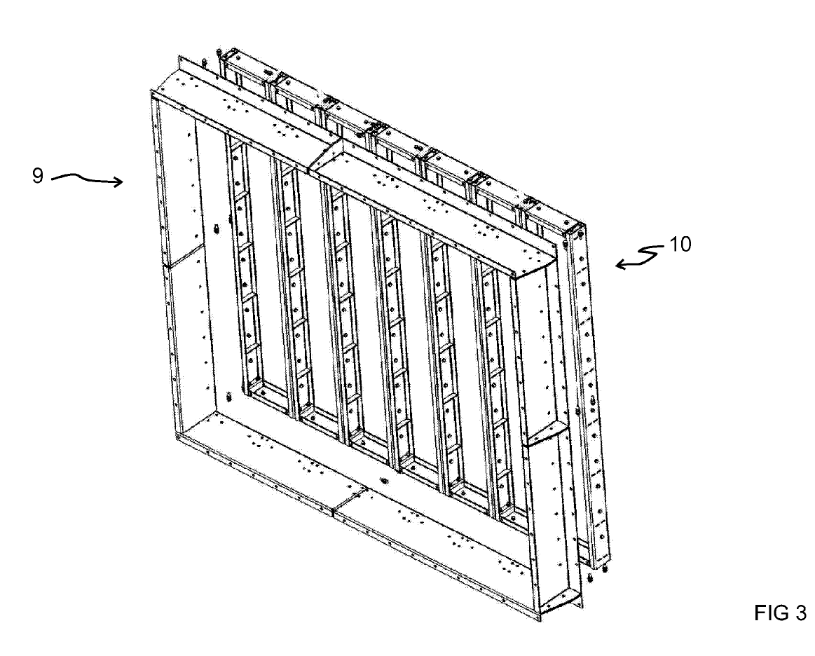

The frame 1 comprises preferably, but not necessarily, as shown in the figures and especially in FIG. 3, an outer frame 9 and an inner frame 10. The inner frame 10 is preferably, but not necessarily connected to the outer frame 9 by means of external fastening means 8. Dividing the frame into an inner frame 9 and an outer frame 10 makes is possible to transport the frame 1 of the blast valve in pieces to the site where the blast valve is mounted, which reduces the transportation costs and makes the transportation easier.

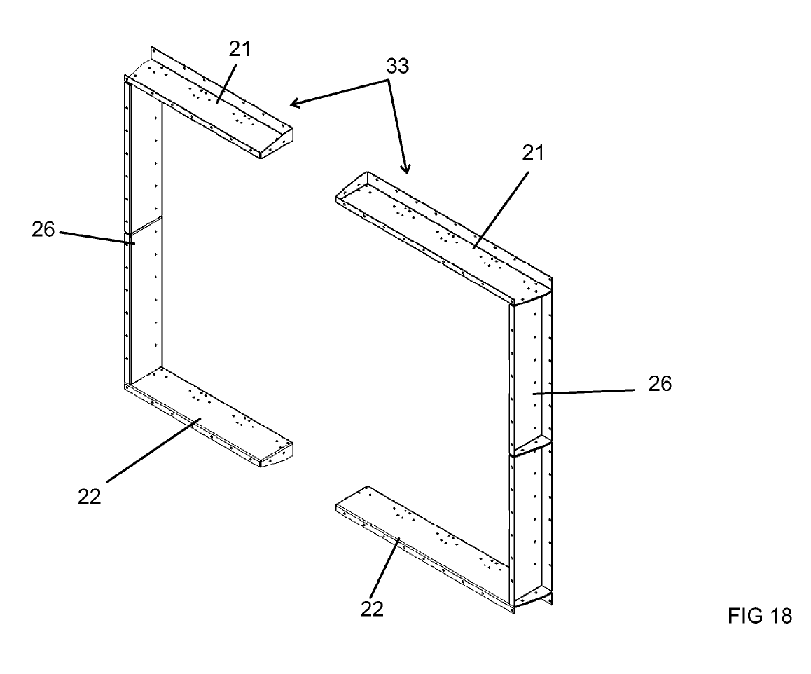

If the frame 1 comprises an outer frame, the outer frame 9 can, as shown in FIG. 18 comprise at least two outer frame sections 33 joined together by external fastening means 8 to form the outer frame 9, wherein each outer frame section 9 comprising an outer lower horizontal beam 22 that forms a part of the elongated bottom member 4 of the frame 1 and of the outer frame 9 and an outer upper horizontal beam 21 that forms a part of the elongated top member 5 of the frame 1 and of the outer frame 9. In such case one outer frame section 33 can comprise an outer vertical beam 26 that forms a part of the first elongated side member 2 of the frame 1, and another outer frame section 33 can comprise an outer vertical beam 26 that forms a part of the second elongated side member 3 of the frame 1. Dividing the outer frame 9 into such outer frame sections 33, facilitates manufacturing and transportation of the blast valve to the site where the blast valve is to be mounted.

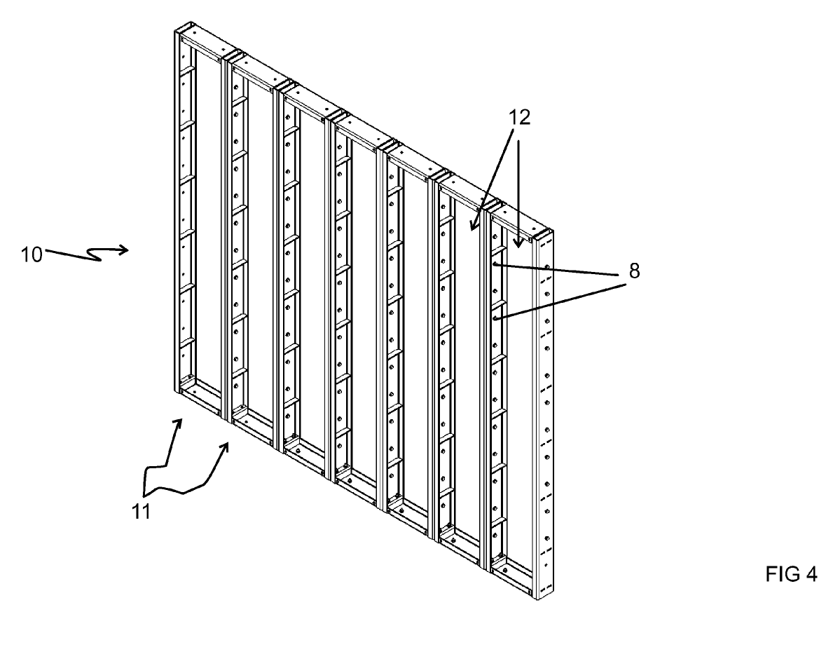

In the embodiment shown in the figures, especially in FIG. 4, the inner frame 10 is formed of a plurality of parallel frame sections 11 each having an opening 12 in which one row of closure devices 7 of said plurality of parallel rows of closure devices 7 is arranged. The closure devices 7 are preferably, but not necessarily, attached to the frame sections 11 forming the inner frame 10 of the frame 1 by means of external fastening means 8. This facilitates transporting of the blast valve to the mounting site, because the blast valve can be transported in pieces, and facilitates mounting of the blast valve at the mounting site. Each frame section 11 comprising a first vertical beam 13, a second vertical beam 14, an upper horizontal beam 15, and a lower horizontal beam 16. The first vertical beam 13 and the second vertical beam 14 are parallel and the upper horizontal beam 15 and the lower horizontal beam 16 are parallel. Each of the first vertical beam 13, the second vertical beam 14, the upper horizontal beam 15, and the lower horizontal beam 16 is formed of a U-beam each having two opposite second ends 30 and each having two flanges 18, a web 19 and a channel 20 between the two flanges 18 and the web 19. One of the opposite second ends 30 of the first vertical beam 13 is connected to a second end 30 of the upper horizontal beam 15 and by the other of the opposite second ends 30 of the first vertical beam 13 is connected to a second end 30 of the lower horizontal beam 16. The connection is preferably, but not necessarily, made by external fastening means 8. One of the opposite second ends 30 of the second vertical beam 14 is connected to a second end 30 of the upper horizontal beam 15 and by the other of the opposite second ends 30 of the second vertical beam 14 is connected to a second end 30 of the lower horizontal beam 16. The connection is preferably, but not necessarily, made by external fastening means 8. The adjacent parallel frame sections 11 of the inner frame 10 are arranged so that the web 19 of the U-beam forming one of a first vertical beam 13 and a second vertical beam 14 is in a parallel frame section 11 in contact with the web 19 of the U-beam forming one of a first vertical beam 13 and a second vertical beam 14 in an adjacent frame section 11. The adjacent parallel frame sections 11 of the inner frame 10 are preferably, but not necessarily, arranged so that the web 19 of the U-beam forming one of a first vertical beam 13 and a second vertical beam 14 in a parallel frame section 11 is in contact with the web 19 of the U-beam forming one of a first vertical beam 13 and a second vertical beam 14 in an adjacent frame section 11 so that the U-beams of the adjacent parallel frame sections 11 forms an I-beam. The adjacent frame sections 11 which are in contact, are preferably, but not necessarily, connected together with external fastening means 8. An advantage of forming the inner frame 10 of a plurality of parallel frame sections 11 is that by using frame sections 11 of one kind i.e. frame sections 11 having standardized dimensions and form, the blast valve can be made smaller by forming the inner frame 10 of a smaller amount of parallel frame sections 11 and larger by forming the inner frame 10 of a larger amount of parallel frame sections 11.

The blast valve comprises preferably, but not necessarily, as shown in the figures, at least two blast valve sections 17 joined together to form the blast valve. In this embodiment, each blast valve sections comprises at least two parallel frame section 11 of said plurality of parallel frame sections 11. Provision of such blast valve sections 17 makes it possible to transport the blast valve in assembled pieces to the site at which the blast valve is to be mounted. In this embodiment, each of said at least two parallel frame sections 11 comprises an upper outer horizontal beam 21, which that forms a part of the elongated top member 5 and the outer frame 9, and a lower outer horizontal beam 22, which forms a part of the elongated bottom member 4 and outer frame 9. The length of the upper outer horizontal beam 21 can be essentially the same as the lower outer horizontal beam 22 in each blast valve section 17. The upper outer horizontal beam 21 is connected to each of said least two parallel frame sections 11 in one of said at least two blast valve sections 17, and the lower outer horizontal beam 22 is connected to each of said least two parallel frame sections 11 in one of said at least two blast valve sections 17. Each blast valve section 17 having at least one connection surface 23 formed in part by the web 19 of one of a first vertical beam 13 and a second vertical beam 14 of a parallel frame section 11 in each blast valve section 17. The blast valve sections 17 are joined together by mating the connection surfaces 23 of adjacent blast valve section 17 and by connecting adjacent blast valve sections 17 by external fastening means 8.

If the blast valve comprises a blast valve sections 17 as described earlier, the upper outer horizontal beam 21, which forms a part of the elongated top member 5 and of the outer frame 9, are preferably, but not necessarily, at the connection surface 23 of the blast valve section 17 provided with an upper connection flange 24, which forms a part of the connection surface 23 of the blast valve section 17. The upper connection flange 24 is preferably, but not necessarily, provided with apertures 29 for external fastening means 8. The upper outer horizontal beam 21 is preferably, but not necessarily, formed of a u-beam having two flanges 18, a web 19, and a channel 20 between the two flanges 18 and the web 19, and the web 19 of the upper outer horizontal beam 21 is preferably, but not necessarily, in contact with the web 19 of the U-beam forming the upper horizontal beam 15 in each frame section 11. Provision of such upper connection flanges 24 makes the blast valve stronger.

If the blast valve comprises at least two blast valve sections 17 as described earlier, the lower outer horizontal beams 22, which forms a part of the elongated bottom member 4 and of the outer frame 9, are preferably, but not necessarily, at the connection surface 23 of the blast valve section 17 provided with a lower connection flange 25, which forms a part of the connection surface 23 of the blast valve section 17. The lower connection flange 25 is preferably, but not necessarily, provided with apertures 29 for external fastening means 8. The lower outer horizontal beam 22 is preferably, but not necessarily, formed of a u-beam having two flanges 18, a web 19, and a channel 20 between the two flanges 18 and the web 19, and the web 19 of the lower outer horizontal beam 22 is preferably, but not necessarily, in contact with the web 19 of the U-beam forming the lower horizontal beam 16 in each frame section 11. Provision of such lower connection flanges 25 makes the blast valve stronger.

If the blast valve comprises at least two blast valve sections 17 as described above, two blast valve sections 17 of the blast valve are preferably, but not necessarily, provided with an outer vertical beam 26 in contact with the web 19 of one of a first vertical beam 13 and a second vertical beam 14 of a parallel frame section 11, wherein the outer vertical beam 26 forms a part of the outer frame 9 and one of the first elongated side member 2 and the second elongated side member 3. The outer vertical beam 26 is preferably but not necessarily, formed of u-beams having two flanges 18, a web 19, and a channel 20 between the two flanges 18 and the web 19. In such case, the web 19 of the outer vertical beam 26 is preferably, but not necessarily, in contact with the web 19 of one of a first vertical beam 13 and a second vertical beam 14 of the parallel frame section 11 of the blast valve section 17. The outer vertical beam 26 is preferably, but not necessarily, formed of at least two outer vertical beam sections 27 connected together by external fastening means 8. Provision of such outer vertical beams 26 makes the blast valve stronger and facilitates mounting of the blast valve.

If the blast valve comprises a plurality of frame sections 11 as described earlier, each first vertical beam 13 and each second vertical beam 14 of each frame section 11 comprises preferably, but not necessarily, reinforcements 28 in the channel 20 of the u-beam and connecting the two flanges 18 and the web 19, and each first vertical beam 13 and each second vertical beam 14 comprises preferably, but not necessarily, reinforcements 28 at each second end 30 of the channel 20 of the u-beam. The reinforcements 28 at each second end 30 of the channel 20 of the u-beam comprises preferably, but not necessarily, apertures 29 for external fastening means 8.

If the blast valve comprises a plurality of frame sections 11 as described earlier, each upper horizontal beam 15 and each lower horizontal beam 16 of each frame section 11 comprises preferably, but not necessarily, reinforcements 28 at each second end 30 of the channel 20 of the u-beam. The reinforcements 28 at each second end 30 of the channel 20 of the u-beam comprises preferably, but not necessarily, apertures 29 for external fastening means 8.

The external fastening means 8 comprises preferably, but not necessarily, bolts and nuts.

It is apparent to a person skilled in the art that as technology advances, the basic idea of the invention can be implemented in various ways. The invention and its embodiments are therefore not restricted to the above examples, but they may vary within the scope of the claims.

1. A blast valve comprising
a frame having a first elongated side member, a second elongated side member, an elongated bottom member, and an elongated top member,
wherein the first elongated side member and the second elongated side member are parallel and wherein the elongated bottom member and the elongated top member are parallel,
wherein each of the first elongated side member, the second elongated side member, the elongated bottom member and the elongated top member have two opposite first ends,
wherein one of opposite first ends of the first elongated side member is attached to a first end of the elongated bottom member and the other of the opposite first ends of the first elongated side member is attached to a first end of the elongated bottom member,
wherein one of opposite first ends of the second elongated side member is attached to a first end of the elongated bottom member and the other of the opposite first end of the second elongated side member is attached to a first end of the elongated bottom member,
wherein a plurality of parallel rows of closure devices arranged in the frame,
wherein the first elongated side member being attached to the elongated bottom member and to the elongated top member by external fastening means, and
wherein the second elongated side member being attached to the elongated bottom member and to the elongated top member by external fastening means.

2. The blast valve according to claim 1,
wherein the frame comprising an outer frame and an inner frame, and
wherein the inner frame being connected to the outer frame by means of external fastening means.

3. The blast valve according to claim 2,
wherein the outer frame comprising at least two outer frame sections joined together by external fastening means to form the outer frame, and
wherein each outer frame section comprising an outer lower horizontal beam that forms a part of the elongated bottom member of the frame and an outer upper horizontal beam that forms a part of the elongated top member of the frame.

4. The blast valve according to claim 3,
wherein one outer frame section that comprises an outer vertical beam that forms a part of the first elongated side member of the frame, and
wherein another outer frame section that comprises an outer vertical beam that forms a part of the second elongated side member of the frame.

5. The blast valve according to claim 2,
wherein the inner frame being formed of a plurality of parallel frame sections each having an opening in which one row of closure devices of said plurality of parallel rows of closure devices is arranged,
wherein each frame section comprising a first vertical beam, a second vertical beam, an upper horizontal beam, and a lower horizontal beam,
wherein the first vertical beam and the second vertical beam are parallel,
wherein the upper horizontal beam and the lower horizontal beam are parallel,
wherein each of the first vertical beam, the second vertical beam, the upper horizontal beam, and the lower horizontal beam being formed of a U-beam each having two opposite second ends and each having two flanges, a web and a channel between the two flanges and the web,
wherein one of the opposite second ends of the first vertical beam being connected to a second end the upper horizontal beam and by the other of the opposite second ends of the first vertical beam being connected to a second end of the lower horizontal beam,
wherein one of the opposite second ends of the second vertical beam being connected to a second end of the upper horizontal beam and by the other of the opposite second ends of the second vertical beam being connected to a second end of the lower horizontal beam, and
wherein the adjacent parallel frame sections of the inner frame being arranged so that the web of the U-beam forming one of a first vertical beam and a second vertical beam in a parallel frame section is in contact with the web of the U-beam forming one of a first vertical beam and a second vertical beam in an adjacent frame section.

6. The blast valve according to claim 5,
wherein the adjacent parallel frame sections of the inner frame being arranged so that the web of the U-beam forming one of a first vertical beam and a second vertical beam in a parallel frame section is in contact with the web of the U-beam forming one of a first vertical beam and a second vertical beam in an adjacent frame section so that the U-beams of the adjacent parallel frame sections together forms an I-beam.

7. The blast valve according to claim 5,
wherein the blast valve comprising at least two blast valve sections joined together to form the blast valve,
wherein each blast valve sections comprising at least two parallel frame sections of said plurality of parallel frame sections,
wherein each of said at least two parallel frame sections comprising an upper outer horizontal beam, which that forms a part of the elongated top member and of the outer frame, and a lower outer horizontal beam, which forms a part of the elongated bottom member and of the outer frame,
wherein the upper outer horizontal beam being connected to each of said least two parallel frame sections in each blast valve section,
wherein the lower outer horizontal beam being connected to each of said least two parallel frame sections in each blast valve section, and
wherein each blast valve section having at least one connection surface formed in part by the web of one of a first vertical beam and a second vertical beam of a parallel frame section of the blast valve section, and
wherein said at least two blast valve sections being joined together by mating the connection surfaces of adjacent blast valve section and by connecting adjacent blast valve sections by external fastening means.

8. The blast valve according to claim 7,
wherein the upper outer horizontal beam, which forms a part of the outer frame, being at the connection surface of the blast valve section provided with an upper connection flange, which forms a part of the connection surface of the blast valve section.

9. The blast valve according to claim 8,
wherein the upper connection flange being provided with apertures for external fastening means.

10. The blast valve according to claim 7,
wherein the upper outer horizontal beam being formed of a u-beam having two flanges, a web, and a channel between the two flanges and the web, and
wherein the web of the upper horizontal beam being in contact with the web of the U-beam forming the upper horizontal beam in each frame section.

11. The blast valve according to claim 7,
wherein the lower outer horizontal beam, which forms a part of the outer frame, being at the connection surface of the blast valve section provided with a lower connection flange, which forms a part of the connection surface of the blast valve section.

12. The blast valve according to claim 11,
wherein the lower connection flange being provided with apertures for external fastening means.

13. The blast valve according to claim 7,
wherein the lower outer horizontal beam being formed of a u-beam having two flanges, a web, and a channel between the two flanges and the web, and
wherein the web of the lower outer horizontal beam being in contact with the web of the U-beam forming the lower horizontal beam in each frame section.

14. The blast valve according to claim 7,
wherein two blast valve sections of the blast valve being provided with an outer vertical beam in contact with the web of one of a first vertical beam and a second vertical beam of a parallel frame section, and
wherein the outer vertical beam forms a part of the outer frame and one of the first elongated side member and the second elongated side member.

15. The blast valve according to claim 14,
wherein the outer vertical beam being formed or u-beams having two flanges, a web, and a channel between the two flanges and the web.

16. The blast valve according to claim 15,
wherein the web of the outer vertical beam being in contact with the web of one of a first vertical beam and a second vertical beam of the parallel frame section of the blast valve section.

17. The blast valve according to claim 14,
wherein the outer vertical beam being formed of at least two outer vertical beam sections connected together by external fastening means.

18. The blast valve according to claim 5
wherein each first vertical beam and each second vertical beam of each frame section comprising reinforcements in the channel of the u-beam and connecting the two flanges and the web, and
wherein each first vertical beam and each second vertical beam comprising reinforcements at each second end of the channel of the u-beam.

19. The blast valve according to claim 18
wherein the reinforcements at each second end of the channel of the u-beam comprising apertures for external fastening means.

20. The blast valve according to claim 5
wherein each upper horizontal beam and each lower horizontal beam of each frame section comprising reinforcements at each second end of the channel of the u-beam.

21. The blast valve according to claim 20,
wherein the reinforcements at each second end of the channel of the u-beam comprising apertures for external fastening means.

22. The blast valve according to claim 1
wherein the frame comprising at least two frame sections joined together by external fastening means to form the frame, and
wherein each frame section comprising an elongated bottom member section that forms a part of the elongated bottom member and an elongated top member section that forms a part of the elongated top member.

23. The blast valve according to claim 22,
wherein one frame section that comprises the first elongated side member, and
wherein another frame section that comprises the second elongated side member.
